(19) United States
(12) Patent Application Publication
(10) Pub. No.: US 2025/0129458 A1
(43) Pub. Date: Apr. 24, 2025

(54) Fe-based Nanocrystalline Alloy Core and Manufacturing Method of Fe-based Nanocrystalline Alloy Core

(71) Applicant: Proterial, Ltd., Tokyo (JP)

(72) Inventors: Kota Inoue, Tokyo (JP); Masahiko Nakahara, Tokyo (JP); Hajime Itagaki, Tokyo (JP)

(21) Appl. No.: 18/920,807

(22) Filed: Oct. 18, 2024

(30) Foreign Application Priority Data
Oct. 20, 2023 (JP) 2023-181402

(51) Int. Cl. C22C 38/02; C21D 6/00; C21D 8/02; C21D 9/52; C22C 38/00; C22C 38/12; C22C 38/16

(52) U.S. Cl. CPC C22C 38/02; C21D 6/008; C21D 8/0205; C21D 9/52; C22C 38/002; C22C 38/12; C22C 38/16; C22C 2200/04

(57) ABSTRACT

An Fe-based nanocrystalline alloy core including a core wound with an Fe-based nanocrystalline alloy ribbon. the Fe-based nanocrystalline alloy ribbon having a thickness of greater than or equal to 11 μm and less than 14 μm, and a space factor of greater than or equal to 73% as measured in accordance with IEC 60404-8-11:2018.

### CROSS REFERENCE TO RELATED APPLICATIONS

The present application claims priority under 35 U.S.C. § 119 to Japanese Patent Application No. 2023-181402 filed on Oct. 20, 2023. The above application is hereby expressly incorporated by reference, in its entirety, into the present application.

### Technical Field

The present disclosure relates to an Fe-based nanocrystalline alloy core and a method of manufacturing an Fe-based nanocrystalline alloy core.

### Related Art

In accordance with the electrification of vehicles and semiconductors using higher frequencies, there is a demand for high impedance materials that cannot be realized with conventional product sizes in order to increase the efficiency and reduce the size of the electronic devices used.

In recent years, Fe-based nanocrystalline alloys have been attracting attention.

For example, Patent Document 1 describes an Fe-based nanocrystalline alloy core including a core wound with an Fe-based nanocrystalline alloy ribbon, the core having an impedance relative magnetic permeability urz of greater than or equal to 90,000 at a frequency of 10 kHz, greater than or equal to 40,000 at a frequency of 100 kHz, and greater than or equal to 8,500 at a frequency of 1 MHz.

### PRIOR ART DOCUMENTS

### Patent Documents

Patent Document 1: International Publication (WO) No. 2015/190528

### SUMMARY

### Problem to be Solved by the Invention

There is a demand for improved magnetic permeability in high frequency bands, in particular, at 100 kHz.

An object of an embodiment of the present disclosure is to provide an Fe-based nanocrystalline alloy core having a higher magnetic permeability than conventional cores, and a method of manufacturing an Fe-based nanocrystalline alloy core.

### Means for Solving the Problem

<1> An Fe-based nanocrystalline alloy core including a core wound with an Fe-based nanocrystalline alloy ribbon, wherein:
the Fe-based nanocrystalline alloy ribbon has a thickness of greater than or equal to 11 μm and less than 14 μm and a space factor of greater than or equal to 73% as measured in accordance with IEC 60404-8-11:2018.
<2> The Fe-based nanocrystalline alloy core according to <1>, wherein:
one surface of the Fe-based nanocrystalline alloy ribbon is a roll surface and another surface of the Fe-based nanocrystalline alloy ribbon is a free surface; and
a maximum profile peak height Rp of the roll surface is greater than or equal to 1.2 μm, and a maximum profile valley depth Rv of the roll surface is less than or equal to 3.7 μm.

<3> The Fe-based nanocrystalline alloy core according to <2>, wherein:
an arithmetic average roughness Ra of the roll surface of the Fe-based nanocrystalline alloy ribbon is less than or equal to 0.6 μm.

<4> The Fe-based nanocrystalline alloy core according to <2> or <3>, wherein:
a maximum cross-sectional height Rt of the roll surface of the Fe-based nanocrystalline alloy ribbon is greater than or equal to 4 μm and less than or equal to 7 μm.
<5> A method of manufacturing an Fe-based nanocrystalline alloy core, including:
winding an Fe-based amorphous alloy ribbon to produce a core precursor; and
heating the core precursor, wherein:
the Fe-based amorphous alloy ribbon has a thickness of greater than or equal to 11 μm and less than 14 μm and a space factor of greater than or equal to 73% as measured in accordance with IEC 60404-8-11:2018.

<6> The method of manufacturing an Fe-based nanocrystalline alloy core according to <5>, wherein:
one surface of the Fe-based amorphous alloy ribbon is a roll surface and another surface of the Fe-based amorphous alloy ribbon is a free surface; and
a maximum profile peak height Rp of the roll surface is greater than or equal to 1.2 μm, and a maximum profile valley depth Rv of the roll surface is less than or equal to 3.7 μm.
<7> The method of manufacturing an Fe-based nanocrystalline alloy core according to <6>, wherein:
an arithmetic average roughness Ra of the roll surface of the Fe-based amorphous alloy ribbon is less than or equal to 0.6 μm.
<8> The method of manufacturing an Fe-based nanocrystalline alloy core according to <6> or <7>, wherein:
a maximum cross-sectional height Rt of the roll surface of the Fe-based amorphous alloy ribbon is from 4 μm to 7 μm.
<9> The method of manufacturing an Fe-based nanocrystalline alloy core according to any one of <5> to <8>, wherein the method further includes producing the Fe-based amorphous alloy ribbon, producing the Fe-based amorphous alloy ribbon including:
supplying a molten alloy of an Fe-based alloy onto a surface of a chill roll; and
spraying atmospheric gas onto the surface of the chill roll onto which the molten alloy is supplied.

### Effect of the Invention

To provide an Fe-based nanocrystalline alloy core having a higher magnetic permeability than conventional cores, and a method of manufacturing an Fe-based nanocrystalline alloy core.

### BRIEF DESCRIPTION OF THE DRAWINGS

FIG. 1 is a schematic cross-sectional view illustrating an example of a manufacturing device for manufacturing an Fe-based amorphous alloy ribbon.

FIG. 2 is a diagram illustrating an example of a circular Fe-based nanocrystalline alloy core.

FIG. 3 is a diagram illustrating an example of an elliptical Fe-based nanocrystalline alloy core.

FIG. 4 is a diagram illustrating an example of a substantially rectangular Fe-based nanocrystalline alloy core.

FIG. 5 is a diagram illustrating heating conditions in the production of an Fe-based nanocrystalline alloy core.

### MODE FOR IMPLEMENTING THE INVENTION

Detailed explanation follows below regarding the present disclosure.

In the present disclosure, a numerical value range expressed by using “(from) . . . to . . . ”, means a range in which the numerical values before and after the word “to” are included as the lower limit value and the upper limit value, respectively.

In the numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. Further, in the numerical value ranges described in the present disclosure, the upper limit value or the lower limit value described in a given numerical range may be replaced with a value shown in the examples.

In the present disclosure, the term “step” includes not only an independent step, but also a step that cannot be clearly distinguished from another step as long as the intended purpose of the step is achieved.

In the present disclosure, an Fe-based nanocrystalline alloy ribbon refers to a ribbon (thin strip) that is configured by an Fe-based nanocrystalline alloy.

Further, in the present disclosure, an Fe-based nanocrystalline alloy refers to a nanocrystalline alloy in which, among the metal elements contained therein, the element having the largest content (atom %) is Fe (iron).

In the present disclosure, an Fe-based amorphous alloy ribbon refers to a ribbon (thin strip) configured by an Fe-based amorphous alloy.

Further, in the present disclosure, an Fe-based amorphous alloy refers to an amorphous alloy in which, among the metal elements contained therein, the element having the largest content (atom %) is Fe (iron).

### Fe-based Nanocrystalline Alloy Core

The Fe-based nanocrystalline alloy core of the present disclosure is a core wound with an Fe-based nanocrystalline alloy ribbon. The Fe-based nanocrystalline alloy ribbon has a thickness of greater than or equal to 11 μm and less than 14 μm, and a space factor of greater than or equal to 73% as measured in accordance with IEC 60404-8-11:2018.

Due to a space factor of the Fe-based nanocrystalline alloy ribbon being greater than or equal to 73%, the Fe-based nanocrystalline alloy core of the present disclosure has a higher magnetic permeability compared to conventional cores.

Patent Document 1 does not include any description focusing on the space factor of the Fe-based nanocrystalline alloy ribbon.

### Fe-based Nanocrystalline Alloy Ribbon

The Fe-based nanocrystalline alloy ribbon has a thickness of greater than or equal to 11 μm and less than 14 μm, and preferably from 11 μm to 12 μm.

Since the thickness of the Fe-based nanocrystalline alloy ribbon is greater than or equal to 11 μm, the Fe-based nanocrystalline alloy ribbon is less likely to break during winding on the core, and can be wound continuously.

Since the thickness of the Fe-based nanocrystalline alloy ribbon is less than 14 μm, the current loss is small and the magnetic permeability of the Fe-based nanocrystalline alloy core is high.

The thickness of the Fe-based nanocrystalline alloy ribbon is measured by the following method.

In accordance with IEC 60404-8-11:2018, conversion can be performed from the mass, length, width, and density of a 2,000 mm long ribbon taken in the casting direction.

The Fe-based nanocrystalline alloy ribbon has a space factor of greater than or equal to 73%, and preferably greater than or equal to 75%. The upper limit value of the space factor is not particularly limited, and is, for example, 77%.

Since the space factor of the Fe-based nanocrystalline alloy ribbon is greater than or equal to 73%, the magnetic permeability of the Fe-based nanocrystalline alloy core is high.

The space factor of the Fe-based nanocrystalline alloy ribbon is measured by the following method.

First, the mass, outer diameter, inner diameter, and height of the Fe-based nanocrystalline alloy core are measured.

The volume of the Fe-based nanocrystalline alloy core is calculated from the outer diameter, inner diameter, and height. The space factor is calculated based on the following formula, using the mass and the volume of the Fe-based nanocrystalline alloy core, and the density of the Fe-based nanocrystalline alloy ribbon.

$$Space factor ( \% ) = mass \div ( volume \times density )$$

The Fe-based nanocrystalline alloy ribbon preferably has a dimension in a width direction of from 30 mm to 300 mm.

In the Fe-based nanocrystalline alloy ribbon, one surface that is in contact with a chill roll during manufacture is preferably formed as a roll surface, and the other surface that is not in contact with the chill roll is preferably formed as a free surface. The roll surface and the free surface can be visually distinguished from each other based on the gloss of the surface of the Fe-based nanocrystalline alloy ribbon. The roll surface has a lower gloss than the free surface because the irregularities of the surface of the chill roll are transferred to the roll surface. Therefore, of the two surfaces of the Fe-based nanocrystalline alloy ribbon, the surface that is relatively glossy is the free surface, and the surface that is relatively non-glossy is the roll surface.

The Fe-based nanocrystalline alloy ribbon preferably has an arithmetic average roughness Ra of the roll surface of less than or equal to 0.6 μm, and more preferably from 0.1 μm to 0.6 μm. By making the arithmetic average roughness Ra of the roll surface of the Fe-based nanocrystalline alloy ribbon less than or equal to 0.6 μm, it is possible to make an Fe-based nanocrystalline alloy ribbon with few irregularities on the surface of the roll surface.

The arithmetic average roughness Ra is measured in accordance with JIS B 0601:2001, with an evaluation length set to 4.0 mm, a cutoff value set to 0.8 mm, and a cutoff type set to 2RC (phase compensation). Here, the direction of the evaluation length is measured at the center of the width direction (direction perpendicular to the casting direction) of the Fe-based nanocrystalline alloy ribbon, along the width direction. The free surface of the Fe-based nanocrystalline alloy ribbon tends to have a larger arithmetic average roughness Ra than the roll surface.

The Fe-based nanocrystalline alloy ribbon preferably has a maximum cross-sectional height Rt of the roll surface of from 4 μm to 7 μm. By making the maximum cross-sectional height Rt of the roll surface of the Fe-based nanocrystalline alloy ribbon equal to or greater than 4 μm, the insulation performance between Fe-based nanocrystalline alloy ribbons is improved when wound around a core, and improved magnetic properties can be expected. By making the maximum cross-sectional height Rt of the roll surface of the Fe-based nanocrystalline alloy ribbon less than or equal to 7 μm, it is possible to obtain an Fe-based nanocrystalline alloy ribbon with few irregularities on the surface of the roll surface, thereby improving the space factor.

The maximum cross-sectional height Rt is measured (evaluated) in accordance with JIS B 0601:2001, with an evaluation length set to 4.0 mm, a cutoff value set to 0.8 mm, and a cutoff type set to 2RC (phase compensation). Here, the direction of the evaluation length is measured at the center of the width direction (direction perpendicular to the casting direction) of the Fe-based nanocrystalline alloy ribbon, along the width direction.

The Fe-based nanocrystalline alloy ribbon preferably has a maximum profile peak height Rp of the roll surface of greater than or equal to 1.2 μm, and more preferably from 1.2 μm to 2.0 μm. By making the maximum profile peak height Rp of the roll surface of the Fe-based nanocrystalline alloy ribbon greater than or equal to 1.2 μm, the insulation performance between Fe-based nanocrystalline alloy ribbons is improved when wound around a core, and improved magnetic properties can be expected.

The maximum profile peak height Rp is measured (evaluated) in accordance with JIS B 0601:2001, with an evaluation length set to 4.0 mm, a cutoff value set to 0.8 mm, and a cutoff type set to 2RC (phase compensation). Here, the direction of the evaluation length is measured at the center of the width direction (direction perpendicular to the casting direction) of the Fe-based nanocrystalline alloy ribbon, along the width direction.

The Fe-based nanocrystalline alloy ribbon preferably has a maximum profile valley depth Rv of the roll surface of less than or equal to 3.7 μm, and more preferably from 0.5 μm to 3.7 μm. By making the maximum profile valley depth Rv of the roll surface of the Fe-based nanocrystalline alloy ribbon less than or equal to 3.7 μm, it is possible to obtain an Fe-based nanocrystalline alloy ribbon with few irregularities on the surface of the roll surface, thereby improving the space factor.

The maximum profile valley depth Rv is measured (evaluated) in accordance with JIS B 0601:2001, with an evaluation length set to 4.0 mm, a cutoff value set to 0.8 mm, and a cutoff type set to 2RC (phase compensation). Here, the direction of the evaluation length is measured at the center of the width direction (direction perpendicular to the casting direction) of the Fe-based nanocrystalline alloy ribbon, along the width direction.

The Fe-based nanocrystalline alloy ribbon preferably has a maximum height Rz of the roll surface of from 3.0 μm to 5.0 μm. By making the maximum height Rz of the roll surface of the Fe-based nanocrystalline alloy ribbon greater than or equal to 3.0 μm, the insulation performance between Fe-based nanocrystalline alloy ribbons is improved when wound around a core, and improved magnetic properties can be expected. By making the maximum height Rz of the roll surface of the Fe-based nanocrystalline alloy ribbon less than or equal to 5.0 μm, it is possible to obtain an Fe-based nanocrystalline alloy ribbon with few irregularities on the surface of the roll surface, thereby improving the space factor.

The maximum height Rz is measured (evaluated) in accordance with JIS B 0601:2001, with an evaluation length set to 4.0 mm, a cutoff value set to 0.8 mm, and a cutoff type set to 2RC (phase compensation). Here, the direction of the evaluation length is measured at the center of the width direction (direction perpendicular to the casting direction) of the Fe-based nanocrystalline alloy ribbon, along the width direction.

The Fe-based nanocrystalline alloy that configures the Fe-based nanocrystalline alloy ribbon preferably has an Fe—Si—B—Cu—Nb series composition in which, among the metal elements contained therein, the element having the largest content (atom %) is Fe (iron).

The Fe-based nanocrystalline alloy contains at least Fe (iron), and preferably further contains Si (silicon) and B (boron), and more preferably contains, in addition to Fe, Si, and B, copper (Cu) and niobium (Nb).

The Fe-based nanocrystalline alloy may further contain C (carbon).

Niobium (Nb) can be replaced with molybdenum (Mo) or vanadium (V), and a portion of iron (Fe) may be replaced with nickel (Ni) or cobalt (Co).

An example of the Fe-based nanocrystalline alloy is an Fe-based nanocrystalline alloy in which, in a case in which the total content of Fe, Si, B, Cu, Nb, C, and unavoidable impurities is 100 atom %, the Fe content is from 72 atom % to 84 atom %, the Si content is from 2 atom % to 20 atom %, the B content is from 5 atom % to 14 atom %, the Cu content is from 0.2 atom % to 2 atom %, the Nb content is from 0.1 atom % to 5 atom %, and the C (carbon) content is less than or equal to 0.5 atom %, with a balance being impurities.

When the Fe content is greater than or equal to 72 atom %, since the saturation magnetic flux density of the alloy ribbon becomes higher, an increase in size or an increase in the weight of a magnetic core manufactured using the alloy ribbon is further suppressed. When the Fe content is less than or equal to 84 atom %, since a decrease in the Curie point and a decrease in the crystallization temperature of the alloy are further suppressed, the stability of the magnetic properties of the magnetic core is further improved.

In addition, when the C (carbon) content is less than or equal to 0.5 atom %, embrittlement of the alloy ribbon is further suppressed. As the C (carbon) content, from 0.1 atom % to 0.5 atom % is preferable. More preferably, the C (carbon) content is from 0.15 atom % to 0.35 atom %.

When the C (carbon) content is greater than or equal to 0.1 atom %, the productivity of the molten alloy and the alloy ribbon is excellent.

More preferable is an Fe-based amorphous alloy in which, in a case in which the total content of Fe, Si, B, Cu, Nb, C, and unavoidable impurities is 100 atom %, the Si content is from 12 atom % to 18 atom %, the B content is from 5 atom % to 10 atom %, the Cu content is from 0.8 atom % to 1.2 atom %, the Nb content is from 2.0 atom % to 4.0 atom %, and the C content is from 0.1 atom % to 0.5 atom %, with a balance being Fe and impurities. Even more preferable is an Fe-based amorphous alloy in which, in a case in which the total content of Fe, Si, B, Cu, Nb, C, and unavoidable impurities is 100 atom %, the Si content is from 14 atom % to 16 atom %, the B content is from 6 atom % to 9 atom %, the Cu content is from 0.9 atom % to 1.1 atom %, the Nb content is from 2.5 atom % to 3.5 atom %, and the C content is from 0.15 atom % to 0.35 atom %, with a balance being Fe and impurities.

In each of the above-described Fe-based amorphous alloys, in a case in which the total content of Fe, Si, and B is 100 atom %, it is preferable that the C (carbon) content is from 0.1 atom % to 0.5 atom %.

### Magnetic Permeability

The Fe-based nanocrystalline alloy core of the present disclosure preferably has a magnetic permeability of greater than or equal to 32,000 at a frequency of 100 kHz, more preferably greater than or equal to 36,000, and even more preferably greater than or equal to 40,000. The upper limit value of the magnetic permeability is, for example, 47,000.

The magnetic permeability here means the real part μr′ of complex magnetic permeability.

The magnetic permeability is calculated in the following manner.

$$μ {r}^{′} = ( ( OD + ID ) \times π \times L ) / ( {μ}_{0} \times ( OD - ID ) \times H \times PF \times {N}^{2} )$$

OD: outer diameter
ID: inner diameter
μ₀: magnetic permeability in a vacuum=4π×10⁻⁷
f: frequency
PF: space factor
H: height
L: inductance
N: number of turns when measuring L (1 turn)

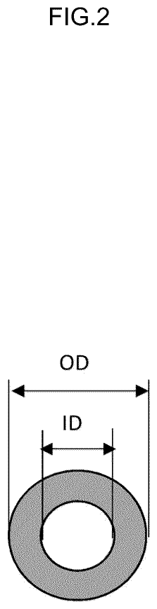

FIG. 2 is a diagram illustrating an example of a circular Fe-based nanocrystalline alloy core.

In FIG. 2, OD indicates the outer diameter, and ID indicates the inner diameter.

The Fe-based nanocrystalline alloy core of the present disclosure has high magnetic permeability at a frequency of 100 kHz, and can suppress noise when installed in electric/electronic devices.

The shape of the Fe-based nanocrystalline alloy core of the present disclosure is not particularly limited, and examples thereof include a circular shape, an elliptical shape, and a substantially rectangular shape.

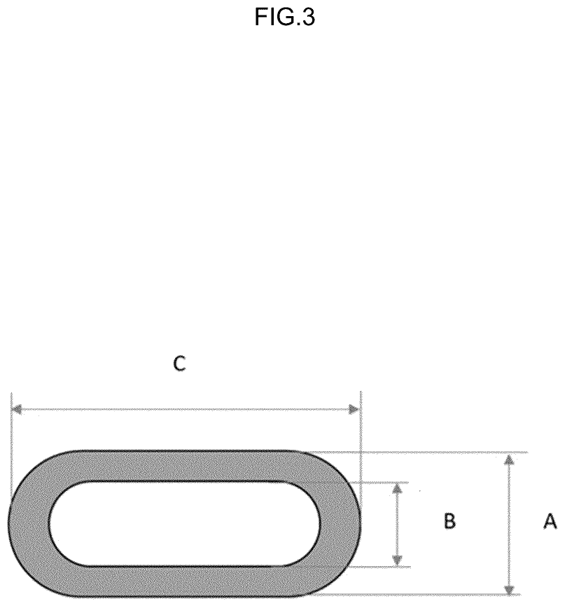

FIG. 3 is a diagram illustrating an example of an elliptical Fe-based nanocrystalline alloy core.

In a case in which the Fe-based nanocrystalline alloy core has an elliptical shape, the magnetic permeability is calculated by the following method.

First, the average magnetic path length and the effective cross-sectional area are calculated.

$$Le : average magnetic path length = 2 ( C - A ) + π ( A + B ) / 2 \\ Ae : effective cross - sectional area = \{ ( A - B ) \times H \times PF \} / 2 \\ μ {r}^{′} = ( Le \times L ) / ( {μ}_{0} \times Ae \times {N}^{2} )$$

A: the narrower width of the outer perimeter of the elliptical shape
B: the narrower width of the inner perimeter of the elliptical shape
C: the wider width of the outer perimeter of the elliptical shape

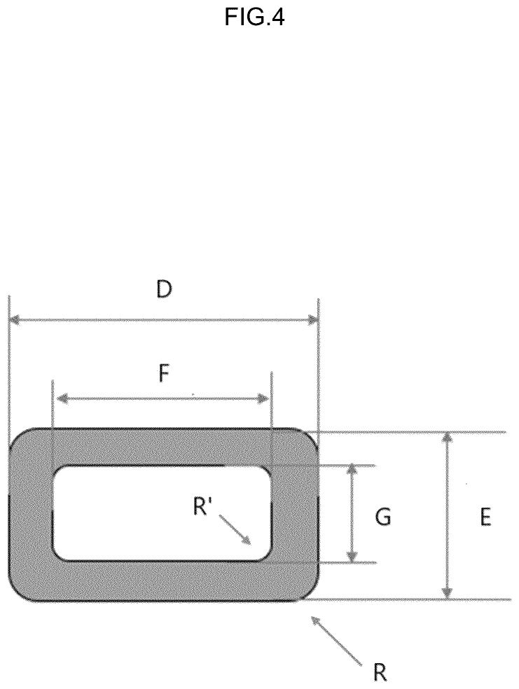

FIG. 4 is a diagram illustrating an example of a substantially rectangular Fe-based nanocrystalline alloy core.

In a case in which the Fe-based nanocrystalline alloy core has a substantially rectangular shape, the magnetic permeability is calculated by the following method.

First, the average magnetic path length and the effective cross-sectional area are calculated.

$$Le : average magnetic path length = ( D - 2 R ) + ( E - 2 R ) + π ( R + {R}^{′} ) \\ Ae : effective cross - sectional area = \{ ( D - F ) \times H \times PF \} / 2 \\ μ {r}^{′} = ( Le \times L ) / ( {μ}_{0} \times Ae \times {N}^{2} )$$

D: the wider width of the outer perimeter of the substantially rectangular shape
E: the narrower width of the outer perimeter of the substantially rectangular shape
F: the wider width of the inner perimeter of the substantially rectangular shape
R: the curvature of the corners of the outer perimeter of the substantially rectangular shape
R′: the curvature of the corners of the inner perimeter of the substantially rectangular shape

The Fe-based nanocrystalline alloy core of the present disclosure is suitable for pulse power magnetic parts and the like used in common mode choke coils, inductors, various transformers, laser power sources, accelerators, and the like. These are coils wound around an Fe-based nanocrystalline alloy core of the present disclosure.

### Method of Manufacturing Fe-based Nanocrystalline Alloy Core

The method of manufacturing the Fe-based nanocrystalline alloy core of the present disclosure includes a step of winding an Fe-based amorphous alloy ribbon to produce a core precursor, and a step of heating the core precursor.

### Step of Producing Core Precursor

The core precursor producing step is a step of winding an Fe-based amorphous alloy ribbon to produce a core precursor.

The Fe-based amorphous alloy ribbon has a thickness of greater than or equal to 11 μm and less than 14 μm, and a space factor of greater than or equal to 73% as measured in accordance with IEC 60404-8-11:2018.

The preferred aspects of the thickness and the space factor of the Fe-based amorphous alloy ribbon are the same as the preferred aspects of the thickness and the space factor of the Fe-based nanocrystalline alloy ribbon.

The method of measuring the thickness and the space factor of the Fe-based amorphous alloy ribbon is the same as the method of measuring the thickness and the space factor of the Fe-based nanocrystalline alloy ribbon.

The preferred composition of the Fe-based amorphous alloy ribbon is the same as the preferred composition of the Fe-based nanocrystalline alloy ribbon.

It is preferable that one surface of the Fe-based amorphous alloy ribbon is a roll surface and the other surface of the Fe-based amorphous alloy ribbon is a free surface. The preferred aspects of the properties of the roll surface of the Fe-based amorphous alloy ribbon are the same as the preferred aspects of the properties of the roll surface of Fe-based nanocrystalline alloy ribbon.

### Step of Heating Core Precursor

The core precursor heating step is a step of heating the core precursor.

In order to crystallize the Fe-based amorphous alloy into an Fe-based nanocrystalline alloy, it is preferable to heat the Fe-based amorphous alloy at a temperature that is higher than the crystallization onset temperature of the Fe-based amorphous alloy.

Specifically, the maximum temperature in the heating step is preferably at least 60° C. higher than the crystallization onset temperature of the Fe-based amorphous alloy.

The crystallization onset temperature is determined by differential scanning calorimetry. It is difficult to accurately measure the true crystallization onset temperature, and identification by differential scanning calorimetry (DSC) is effective. During the temperature rise, the temperature at which an exothermic reaction due to the onset of nanocrystallization is detected is taken as the crystallization onset temperature. The crystallization onset temperature is measured at a temperature rise rate of 10° C./min.

In the heating step, it is preferable to apply a magnetic field in a height direction of the core precursor.

The strength of the applied magnetic field is preferably from 50 kA/m to 300 kA/m, and more preferably from 60 kA/m to 280 kA/m.

The method of manufacturing an Fe-based nanocrystalline alloy core of the present disclosure may include a step of producing an Fe-based amorphous alloy ribbon.

### Step of Producing Fe-based Amorphous Alloy Ribbon

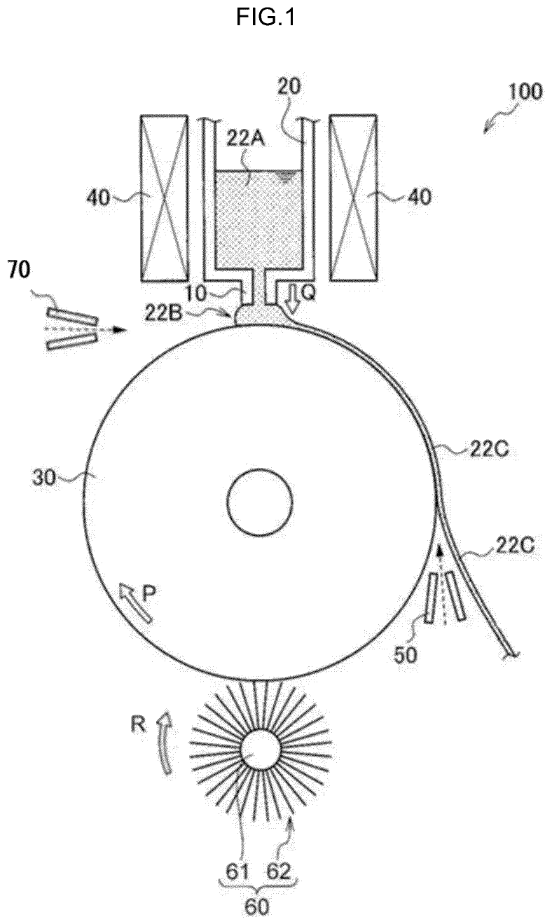

The method of manufacturing the Fe-based amorphous alloy ribbon will be described with reference to FIG. 1.

FIG. 1 is a schematic cross-sectional view illustrating an example of a manufacturing device for manufacturing an Fe-based amorphous alloy ribbon. FIG. 1 illustrates a cross section of an alloy ribbon manufacturing device taken along a plane perpendicular to an axial direction of a chill roll 30 and a width direction of the alloy ribbon. Here, an alloy ribbon 22C is an example of an Fe-based amorphous alloy ribbon according to one embodiment of the present disclosure. Furthermore, the axial direction of the chill roll 30 and the width direction of the alloy ribbon 22C are the same direction.

As illustrated in FIG. 1, the alloy ribbon manufacturing device 100 includes a crucible 20 equipped with a molten metal nozzle 10, and the chill roll 30 has an outer peripheral surface that faces a tip of the molten metal nozzle 10.

The crucible 20 has an internal space capable of accommodating a molten alloy 22A that is the raw material of the alloy ribbon 22C, and the internal space is in communication with a molten metal flow path in the molten metal nozzle 10. This allows the molten alloy 22A accommodated in the crucible 20 to be discharged onto the chill roll 30 by the molten metal nozzle 10 (in FIG. 1, a discharge direction and a flow direction of the molten alloy 22A are indicated by the arrow Q). The crucible 20 and the molten metal nozzle 10 may be configured integrally or may be configured separately.

A high-frequency coil 40, which serves as a heating means, is disposed at least partially around the periphery of crucible 20. This makes it possible to heat the crucible 20 in a state in which the mother alloy of the alloy ribbon is accommodated therein, so as to generate molten alloy 22A within the crucible 20, and to maintain the liquid state of the molten alloy 22A supplied to the crucible 20 from the outside.

Further, the molten metal nozzle 10 also has an opening (discharge port) for discharging the molten alloy in the direction of the arrow Q. The opening is preferably a rectangular (slit-shaped) opening.

A distance (closest distance) between the tip of the molten metal nozzle 10 and the outer peripheral surface of the chill roll 30 is close enough such that a puddle 22B (a pool of molten metal) is formed when the molten metal nozzle 10 discharges the molten alloy 22A.

The chill roll 30 rotates about its axis in a rotation direction P. A cooling medium such as water flows inside the cooling roll 30 so that a coating film of the molten alloy formed on the outer peripheral surface of the cooling roll 30 can be cooled. The coating film of the molten alloy is cooled to produce the alloy ribbon 22C (Fe-based amorphous alloy ribbon).

Examples of materials for the chill roll 30 include Cu and Cu alloys (Cu—Be alloy, Cu—Cr alloy, Cu—Zr alloy, Cu—Cr—Zr alloy, Cu—Ni alloy, Cu—Ni—Si alloy, Cu—Ni—Si—Cr alloy, Cu—Zn alloy, Cu—Sn alloy, Cu—Ti alloy, and the like), with Cu alloys being preferred in terms of high thermal conductivity, and Cu—Be alloy, Cu—Cr—Zr alloy, Cu—Ni alloy, Cu—Ni—Si alloy, or Cu—Ni—Si—Cr alloy being more preferred.

Although there is no particular limitation on the surface roughness of the outer peripheral surface of the chill roll 30, the arithmetic average roughness (Ra) of the outer peripheral surface of the chill roll 30 is preferably from 0.1 μm to 0.5 μm, and more preferably from 0.1 μm to 0.3 μm. When the arithmetic average roughness Ra of the outer peripheral surface of the chill roll 30 is less than or equal to 0.5 μm, the space factor is further improved when manufacturing a wound magnetic core using the alloy ribbon. When the arithmetic average roughness Ra of the outer peripheral surface of the chill roll 30 is greater than or equal to 0.1 μm, it is easier to adjust the Ra.

From the viewpoint of cooling capability, a diameter of the chill roll 30 is preferably from 200 mm to 1,000 mm, and more preferably from 300 mm to 800 mm. Further, although a rotation speed of the chill roll 30 can be within the range normally set in a single roll method, a circumferential speed of from 10 m/s to 40 m/s is preferable, and a circumferential speed of from 20 m/s to 30 m/s is more preferable.

The alloy ribbon manufacturing device 100 further includes a peeling gas nozzle 50 downstream of the molten metal nozzle 10 in a rotation direction of the chill roll 30 (hereinafter simply referred to as the “downstream side”) as a peeling means that peels off the Fe-based amorphous alloy ribbon from the outer peripheral surface of the chill roll 30. In this example, the alloy ribbon 22C is peeled off from the chill roll 30 by spraying a peeling gas from the peeling gas nozzle 50 in the opposite direction to the rotation direction P of the cooling roll 30 (the direction of the dashed arrow in FIG. 1). As the peeling gas, for example, nitrogen gas or a high pressure gas such as compressed air can be used.

The alloy ribbon manufacturing device 100 further includes a polishing brush roll 60 at the downstream side of the peeling gas nozzle 50 as a polishing means for polishing the outer peripheral surface of the chill roll 30. The polishing brush roll 60 includes a roll shaft member 61 and a polishing brush 62 arranged around the roll shaft member 61. The polishing brush 62 is configured by a non-woven fabric coated with plural abrasive grains. The polishing brush roll 60 rotates about its axis in a direction of rotation R, thereby polishing the outer peripheral surface of the chill roll 30 with the non-woven fabric of the polishing brush 62.

The purpose of polishing by the above-described polishing means (for example, the polishing brush roll 60) is not necessarily limited to scraping the outer peripheral surface of the chill roll, and also includes removing any residue remaining on the outer peripheral surface of the chill roll. The purpose of the polishing is preferably at least one of the following first and second purposes.

The first purpose is to repair deterioration of the smoothness of the outer peripheral surface of the chill roll. In detail, when the molten alloy and the outer peripheral surface of the chill roll first come into contact with each other, a very small portion of the outer peripheral surface (for example, Cu alloy) of the chill roll dissolves in the molten alloy, and minute recessed portions (an omitted portion) are formed on the outer peripheral surface of the chill roll, which may cause deterioration of the smoothness of the outer peripheral surface of the chill roll. Deterioration of the smoothness of the outer peripheral surface of the chill roll may cause deterioration of the smoothness of the roll surface of the manufactured alloy ribbon (the surface that was in contact with the outer peripheral surface of the cooling roll; the same below). Even in a case in which the smoothness of the outer peripheral surface of the chill roll is deteriorated, the above-described polishing can be used to almost evenly remove the portions that are convex (that is, the portions where dissolution has been suppressed) relative to the minute recessed portion (an omitted portion), thereby repairing the deterioration of the smoothness of the outer peripheral surface of the chill roll. As a result, deterioration of the smoothness of the roll surface of the alloy ribbon caused by deterioration of the smoothness of the outer peripheral surface of the chill roll can be suppressed.

The second purpose is to remove the residue (alloy) remaining on the outer peripheral surface of the chill roll after the alloy ribbon has been peeled off. The molten alloy discharged onto the outer peripheral surface of the chill roll is rapidly cooled to form an alloy ribbon, which is then peeled off from the outer peripheral surface of the chill roll. At this time, a part of the alloy, which is the material of the alloy ribbon, may not be peeled off from the outer peripheral surface of the chill roll and may remain as a residue, and this residue may adhere to the outer peripheral surface of the chill roll and form convex portions. Since the casting of the alloy ribbon is carried out continuously, the molten alloy is again discharged onto the outer peripheral surface of the chill roll on which the convex portions caused by the above-described residue have been formed. As a result, recessed portions may be formed on the roll surface of the manufactured alloy ribbon at positions corresponding to the above-described convex portions, and the smoothness of the roll surface of the alloy ribbon may be deteriorated. Furthermore, in a case in which the thermal conductivity of the residue (alloy) that configures the above-described convex portions is lower than the thermal conductivity of the outer peripheral surface (for example, Cu alloy) of the chill roll, the rapid cooling characteristics of the chill roll may be locally deteriorated at the above-described convex portions, and the magnetic properties of the alloy ribbon may be reduced. Even in a case in which the above-described residue remains on the outer peripheral surface of the chill roll after the alloy ribbon is peeled off, the residue can be removed by the above-described polishing. As a result, deterioration of the smoothness of the roll surface of the alloy ribbon caused by the above-described residue can be suppressed. In addition, reduction of the magnetic properties of the alloy ribbon caused by the above-described residue can be suppressed.

The alloy ribbon manufacturing device 100 further includes an atmospheric gas nozzle 70 for spraying (supplying) atmospheric gas onto the surface of the chill roll onto which the molten alloy is supplied.

The atmospheric gas sprayed from the atmospheric gas nozzle 70 is carbon dioxide gas or carbon monoxide gas in order to control the gas atmosphere in the vicinity of the roll surface at the nozzle tip.

The alloy ribbon manufacturing device 100 may include elements other than those described above (for example, a winding roll for winding up the manufactured alloy ribbon 22C, and the like).

Next, an example of a manufacturing method of the alloy ribbon 22C using the alloy ribbon manufacturing device 100 will be described. First, the molten alloy 22A serving as the raw material for the alloy ribbon 22C is prepared in the crucible 20. The temperature of the molten alloy 22A is appropriately set in consideration of the composition of the alloy, and is, for example, from 1210° C. to 1410° C., preferably from 1280° C. to 1400° C.

Next, the molten alloy is discharged by the molten alloy nozzle 10 onto the outer peripheral surface of the chill roll 30 which rotates about its axis in the rotation direction P, and a coating film of the molten alloy is formed while forming the puddle 22B. The formed coating film is cooled on the outer peripheral surface of the chill roll 30 to form the alloy ribbon 22C on the outer peripheral surface. Next, the alloy ribbon 22C formed on the outer peripheral surface of the chill roll 30 is peeled off from the outer peripheral surface of the chill roll 30 by spraying the peeling gas from the peeling gas nozzle 50, and is wound up into a roll by a winding roll, which is not illustrated in the drawings, and collected. On the other hand, the outer peripheral surface of the chill roll 30 after the alloy ribbon 22C has been peeled off is polished by the polishing brush 62 of the polishing brush roll 60 that rotates about its axis in the rotation direction R. The molten alloy is again discharged onto the polished outer peripheral surface of the chill roll 30. By repeating the above-described operations, a long alloy ribbon 22C is continuously produced (cast).

The manufacturing method of an Fe-based nanocrystalline alloy core of the present disclosure may include, after the step of heating the core precursor, a step of impregnating the core with an epoxy resin diluted with an organic solvent. After the impregnation, it is preferable to carry out drying.

### EXAMPLES

Examples of the present disclosure are provided below; however, the present disclosure is not limited to the following examples.

### Production of Fe-based Amorphous Alloy Ribbon

An alloy ribbon manufacturing device similar to the alloy ribbon manufacturing device 100 illustrated in FIG. 1 was prepared. As the chill roll, a chill roll having an outer peripheral surface made of a Cu—Be alloy, a diameter of 400 mm, and an arithmetic average roughness Ra of the outer peripheral surface of 0.3 μm was used.

First, in a crucible, a molten alloy consisting of Fe, Si, B, Cu, Nb, C, and inevitable impurities (hereinafter also referred to as an “Fe—Si—B—Cu—Nb based molten alloy”) was prepared. Specifically, pure iron, ferrosilicon, and ferroboron were mixed and melted, and a molten alloy was prepared in which, in a case in which the total content of Fe, Si, B, Cu, Nb, C, and unavoidable impurities is 100 atom %, the Si content is 15 atom %, the B content is 7 atom %, the Cu content is 1 atom %, the Nb content is 3 atom %, and the C content is 0.2 atom %, with the remainder being Fe and unavoidable impurities. The atomic percentage values are amounts measured by sampling a portion of the alloy from the molten metal and subjecting it to ICP atomic emission spectrometry.

Next, the Fe—Si—B—Cu—Nb based molten alloy was discharged from an opening of a molten metal nozzle, the opening being rectangular (slit-shaped) and having a long side length of 53 mm and a short side length of 0.3 mm, onto the outer peripheral surface of a rotating chill roll and rapidly solidified to produce (cast) 500 kg of an amorphous alloy ribbon with a ribbon width of 53 mm. The casting time was 60 minutes, and the alloy ribbon was cast continuously without breakage. The casting was carried out while the outer peripheral surface of the chill roll was polished with a polishing brush (non-woven fabric) of a polishing brush roll.

Details of the casting conditions are indicated below.
Casting Conditions
molten alloy temperature: from 1350° C. to 1390° C.
circumferential speed of chill roll: from 20 m/s to 30 m/s
discharge pressure of molten alloy: adjusted within a range of from 5 kPa to 30 kPa distance (gap) between tip of molten metal nozzle and outer peripheral surface of chill roll: adjusted within a range of from 0.1 mm to 0.35 mm

### Production of Fe-based Nanocrystalline Alloy Core

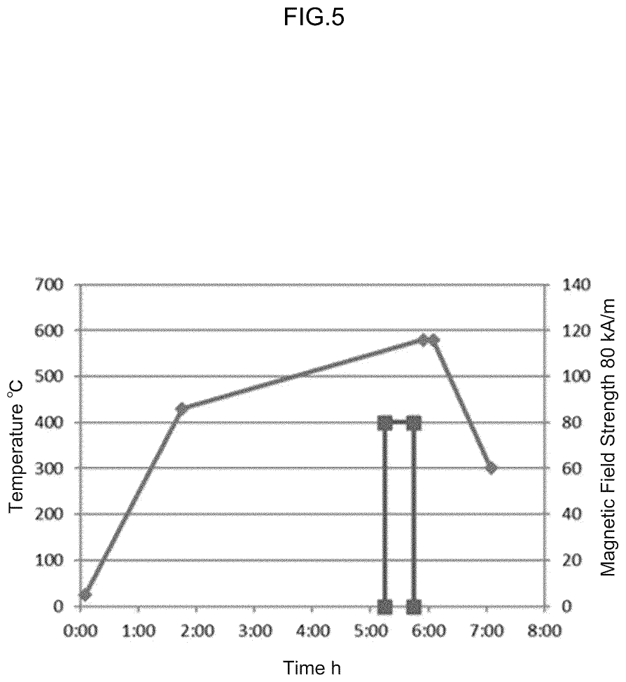

The obtained Fe-based amorphous alloy ribbon was wound to produce a core precursor. The core precursor was heated according to the profile illustrated in FIG. 5 to produce an Fe-based nanocrystalline alloy core.

Specifically, the core precursor was maintained at 25° C. for 5 minutes, heated to 430°° C. over 1 hour and 40 minutes, heated to 580° C. over 4 hours and 10 minutes, maintained at 580°° C. for 10 minutes, and then cooled to 300° C. over 1 hour. Furthermore, a magnetic field of 80 kA/m was applied for 30 minutes at a temperature in the range of from 520° C. to 580° C.

In Example 1 and Comparative Example 1, the tension applied to the Fe-based amorphous alloy ribbon was adjusted to produce the space factor shown in Table 1.

The magnetic permeability of the produced Fe-based nanocrystalline alloy core was measured. The measurement results are shown in Table 1.

TABLE 1

| | Thickness | Space | Magnetic Permeability | | | | |
|---|---|---|---|---|---|---|---|
| | (μm) | Factor (%) | 1 kHz | 10 kHz | 100 kHz | 1 MHz | 10 MHz |
| Example 1 | 12 | 75 | 60251.9 | 59323.4 | 38612.6 | 6747.86 | 947.624 |
| Comparative | 14 | 70 | 56774.5 | 55796.6 | 31375.4 | 5452.8 | 747.61 |
| Example 1 | | | | | | | |

As shown in Table 1, in Example 1, the core is wound with an Fe-based nanocrystalline alloy ribbon, and since the Fe-based nanocrystalline alloy ribbon has a thickness of greater than or equal to 11 μm and less than 14 μm, and the space factor as measured in accordance with IEC 60404-8-11:2018 is greater than or equal to 73%, it was found that the magnetic permeability is higher than that of Comparative Example 1.

In Example 1, the magnetic permeability was greater than or equal to 32,000 at a frequency of 100 kHz.

### Example 100

Next, the above-described Fe-based amorphous alloy ribbon was used to produce a circular Fe-based nanocrystalline alloy core.

The outer diameter, the inner diameter, the height, and the weight are shown in Table 2. The magnetic permeability is the magnetic permeability at a frequency of 100 kHz.

TABLE 2

| Outer Diameter | Inner Diameter | Height | Weight | Magnetic |
|---|---|---|---|---|
| (mm) | (mm) | (mm) | (g) | Permeability |
| 27.28 | 20.77 | 10 | 13.56 | 36516 |
| 27.24 | 20.78 | 10 | 13.86 | 36360 |
| 27.16 | 20.79 | 10 | 13.79 | 35701 |
| 40.9 | 30.7 | 30 | 89.3 | 37066 |
| 31.27 | 21.05 | 15 | 34.63 | 35652 |
| 31.52 | 20.8 | 15 | 35.79 | 36123 |
| 31.5 | 20.82 | 15 | 35.36 | 36645 |

### Example 200

A circular Fe-based nanocrystalline alloy core was produced by the same method as in Example 100, except that an impregnation step was carried out after the heating step of the core precursor.

In the impregnation step, the heated core was impregnated with epoxy resin diluted with acetone.

The outer diameter, the inner diameter, the height, and the weight are shown in Table 3. The magnetic permeability is the magnetic permeability at a frequency of 100 kHz.

TABLE 3

| Outer Diameter | Inner Diameter | Height | Weight | Magnetic |
|---|---|---|---|---|
| (mm) | (mm) | (mm) | (g) | Permeability |
| 27.19 | 20.78 | 10 | 13.52 | 36024 |
| 27.28 | 20.74 | 10 | 14.09 | 37567 |
| 59.57 | 48.41 | 30 | 158.72 | 35971 |
| 31.46 | 20.69 | 15 | 35.27 | 35577 |
| 31.47 | 20.79 | 15 | 35.25 | 36145 |
| 31.48 | 20.76 | 15 | 25.21 | 36711 |

### Example 300

A circular Fe-based nanocrystalline alloy core was produced and then molded to produce an elliptical Fe-based nanocrystalline alloy core as illustrated in FIG. 3.

The outer diameter, the inner diameter, the height, and the weight, before molding, are shown in Table 4. The magnetic permeability is the magnetic permeability at a frequency of 100 kHz.

In Table 4, “A” after molding means the narrower width of the outer perimeter of the elliptical shape, and “B” after molding means the narrower width of the inner perimeter of the elliptical shape.

TABLE 4

| Before Molding | | | | | | | |
|---|---|---|---|---|---|---|---|
| Outer | Inner | | | After Molding | | Magnetic Permeability | |
| Diameter | Diameter | Height | Weight | A | B | After Heat | After |
| (mm) | (mm) | (mm) | (g) | (mm) | (mm) | Treatment | Impregnation |
| 45.65 | 31.00 | 15 | 71.66 | 29.89 | 15.03 | 37821 | 38468 |

### Example 400

A circular Fe-based nanocrystalline alloy core was produced and then molded to produce a substantially rectangular Fe-based nanocrystalline alloy core as illustrated in FIG. 4.

The outer diameter, the inner diameter, the height, and the weight, before molding, are shown in Table 5. The magnetic permeability is the magnetic permeability at a frequency of 100 kHz.

In Table 5, “D” after molding means the wider width of the outer perimeter of the substantially rectangular shape, “E” after molding means the narrower width of the outer perimeter of the substantially rectangular shape, “F” after molding means the wider width of the inner perimeter of the substantially rectangular shape, and “G” after molding means the narrower width of the inner perimeter of the substantially rectangular shape.

TABLE 5

| Before Molding | | | | | | | | | |
|---|---|---|---|---|---|---|---|---|---|
| Outer | Inner | | | After Molding | | | | Magnetic Permeability | |
| Diameter | Diameter | Height | Weight | D | E | F | G | After Heat | After |
| (mm) | (mm) | (mm) | (g) | (mm) | (mm) | (mm) | (mm) | Treatment | Impregnation |
| 40.88 | 30.46 | 15 | 45.45 | 40.56 | 29.98 | 29.95 | 18.79 | 35690 | 35451 |

From Example 100 to Example 400, it was found that Fe-based nanocrystalline alloy cores of various shapes having a magnetic permeability of greater than or equal to 32,000 at 100 kHz could be obtained.
10: molten metal nozzle
20: crucible
30: chill roll
40: high frequency coil
50: peeling gas nozzle
60: polishing brush roll
70: atmospheric gas nozzle
100: alloy ribbon manufacturing device

What is claimed is:

1. An Fe-based nanocrystalline alloy core comprising a core wound with an Fe-based nanocrystalline alloy ribbon, wherein:
the Fe-based nanocrystalline alloy ribbon has a thickness of greater than or equal to 11 μm and less than 14 μm and a space factor of greater than or equal to 73% as measured in accordance with IEC 60404-8-11:2018.

2. The Fe-based nanocrystalline alloy core according to claim 1, wherein:
one surface of the Fe-based nanocrystalline alloy ribbon is a roll surface and another surface of the Fe-based nanocrystalline alloy ribbon is a free surface; and
a maximum profile peak height Rp of the roll surface is greater than or equal to 1.2 μm, and a maximum profile valley depth Rv of the roll surface is less than or equal to 3.7 μm.

3. The Fe-based nanocrystalline alloy core according to claim 2, wherein:
an arithmetic average roughness Ra of the roll surface of the Fe-based nanocrystalline alloy ribbon is less than or equal to 0.6 μm.

4. The Fe-based nanocrystalline alloy core according to claim 2, wherein:
a maximum cross-sectional height Rt of the roll surface of the Fe-based nanocrystalline alloy ribbon is greater than or equal to 4 μm and less than or equal to 7 μm.

5. A method of manufacturing an Fe-based nanocrystalline alloy core, comprising:
winding an Fe-based amorphous alloy ribbon to produce a core precursor; and
heating the core precursor, wherein:
the Fe-based amorphous alloy ribbon has a thickness of greater than or equal to 11 μm and less than 14 μm and a space factor of greater than or equal to 73% as measured in accordance with IEC 60404-8-11:2018.

6. The method of manufacturing an Fe-based nanocrystalline alloy core according to claim 5, wherein:
one surface of the Fe-based amorphous alloy ribbon is a roll surface and another surface of the Fe-based amorphous alloy ribbon is a free surface; and
a maximum profile peak height Rp of the roll surface is greater than or equal to 1.2 μm, and a maximum profile valley depth Rv of the roll surface is less than or equal to 3.7 μm.

7. The method of manufacturing an Fe-based nanocrystalline alloy core according to claim 6, wherein:
an arithmetic average roughness Ra of the roll surface of the Fe-based amorphous alloy ribbon is less than or equal to 0.6 μm.

8. The method of manufacturing an Fe-based nanocrystalline alloy core according to claim 6, wherein:
a maximum cross-sectional height Rt of the roll surface of the Fe-based amorphous alloy ribbon is from 4 μm to 7 μm.

9. The method of manufacturing an Fe-based nanocrystalline alloy core according to claim 5, wherein the method further comprises producing the Fe-based amorphous alloy ribbon, producing the Fe-based amorphous alloy ribbon comprising:
supplying a molten alloy of an Fe-based alloy onto a surface of a chill roll; and
spraying atmospheric gas onto the surface of the chill roll onto which the molten alloy is supplied.
